(19) United States
(12) Patent Application Publication
(10) Pub. No.: US 2009/0216642 A1
(43) Pub. Date: Aug. 27, 2009

(54) PRIVACY-ENHANCED INTERNET ADVERTISING SYSTEM

(75) Inventors: Michael Ho, Toronto (CA); Nicolas St-Pierre, Toronto (CA)

Correspondence Address: BERESKIN AND PARR LLP/S.E.N.C.R.L., s.r.l., 40 KING STREET WEST, BOX 401, TORONTO, ON, M5H 3Y2, CA

(73) Assignee: BERING MEDIA INCORPORATED, Toronto (CA)

(21) Appl. No.: 12/361,566

(22) Filed: Jan. 29, 2009

Related U.S. Application Data
(60) Provisional application No. 61/031,296, filed on Feb. 25, 2008.

(51) Int. Cl. G06Q 30/00

(52) U.S. Cl. 705/14

(57) ABSTRACT

A system and method of advertising for determining a network location associated with a physical location. In one aspect, a system for performing this function is described which includes an advertiser module for accepting advertisements and a targeting criterion and computing a plurality of restricted identifiers satisfying the targeting criterion, an association module for receiving the plurality of restricted identifiers, associating the plurality of restricted identifiers with a plurality of non-restricted identifiers, and an intermediate module for associating the advertisement identifier with the plurality of non-restricted identifiers.

### CROSS-REFERENCE TO RELATED APPLICATIONS

This application claims priority from provisional U.S. Application No. 61/031,296 filed on Feb. 25, 2008.

### FIELD

The embodiments described herein relate to systems and methods for advertising and in particular to systems and methods for providing advertisements over a network

### INTRODUCTION

Advertisements are delivered in a wide variety of forms and media. On computer networks such as the Internet, and on the World-Wide Web (web) in particular, advertisements are generally embedded within web pages. Such web advertisements appear in many forms, including text, audio, images, video and interactive applications. The advertisements may be statically embedded within the web pages, meaning that they are hard-coded within the markup code of the web page. Alternatively, advertisements may be dynamically or programmatically embedded within the web pages.

In the case of dynamically embedded web advertisements, the web server supplying the web page may choose, based on an algorithm, from among a number of web advertisements available for embedding. The algorithm may be a simple rotation algorithm, whereby the web server progressively iterates through the list of web advertisements upon each request for a web page. Alternatively, the algorithm may simply provide for a pseudo-random selection. More sophisticated algorithms select advertisements based on information known about the requesting client. For example, metadata supplied by a web browser client in the Hypertext Transfer Protocol (HTTP) request header may include such information as Internet Protocol (IP) address, web browser version, preferred language, etc.

IP addresses identify devices, such as client computers and web servers, connected to a computer network such as the Internet. IP addresses are allocated to network service providers and other parties by the Internet Assigned Numbers Authority (IANA). In the case of a network service provider, IP addresses are re-allocated to subscribers, typically on an as-needed basis using the Dynamic Host Configuration Protocol (DHCP). For example, to connect a personal computer to the Internet, a subscriber may connect it to a network access device, such as a digital subscriber line (DSL) or cable modem. The modem connects to the network service provider's network using the appropriate access technology and, upon connection, is dynamically assigned (i.e., leased) an IP address from a pool reserved for the use of the network service provider. If the subscriber disconnects the modem, the IP address allocation is released when the lease expires and may be provided to another subscriber. Upon a subsequent connection, the subscriber may be assigned a different IP address.

### SUMMARY

In one broad aspect, at least one embodiment described herein provides an advertising system for determining a network location associated with a physical location. The system comprises an advertiser module having a first communication interface, for accepting an advertisement identifier and a targeting criterion associated with an advertisement, computing a plurality of restricted identifiers satisfying the targeting criterion, and storing the advertisement identifier, the targeting criterion and the plurality of restricted identifiers in a first computer database, wherein the advertisement identifier identifies the advertisement; an intermediate module having a second communication interface, for receiving the advertisement identifier and the plurality of restricted identifiers from the advertiser module, storing the advertisement identifier and the plurality of restricted identifiers in a second computer database, communicating the plurality of restricted identifiers to at least one service provider, receiving an indication of a plurality of non-restricted identifiers associated with the plurality of restricted identifiers, and associating the advertisement identifier with the plurality of non-restricted identifiers; and an association module operated by the at least one service provider having a third communication interface, the association module for receiving the plurality of restricted identifiers, associating the plurality of restricted identifiers with the plurality of non-restricted identifiers stored in a third computer database, and communicating the indication of the plurality of non-restricted identifiers to the intermediate module.

In another broad aspect, at least one embodiment described herein provides an advertising method for determining a network location associated with a physical location. The method comprises providing an advertiser module, an intermediate module and an association module, wherein each of the modules has a communication interface; receiving an advertisement campaign and a targeting criterion associated with the advertisement campaign at the advertiser module; computing an advertisement identifier and a plurality of restricted identifiers satisfying the targeting criterion, storing the advertisement identifier, the targeting criterion and the plurality of restricted identifiers in a first computer database and communicating the advertisement identifier and the plurality of restricted identifiers to the intermediate module; receiving the advertisement identifier and the plurality of restricted identifiers at the intermediate module and storing the advertisement identifier and the plurality of restricted identifiers in a second computer database; communicating the plurality of restricted identifiers to the association module; computing at the association module a plurality of non-restricted identifiers, drawn from a third computer database, associated with the plurality of restricted identifiers; communicating an indication of the plurality of non-restricted identifiers associated with the plurality of restricted identifiers to the intermediate module; and based on the indication, associating the advertisement identifier to the plurality of non-restricted identifiers.

In at least some embodiments, the method further comprises receiving a maximum bid amount associated with the advertisement campaign; receiving at least one additional advertisement campaign with at least one associated maximum bid amount and at least one associated targeting criterion; and, where the plurality of restricted identifiers satisfies both the targeting criterion and the at least one associated targeting criterion, associating the advertisement campaign associated with the highest maximum bid amount.

In some embodiments, the method comprises communicating a prohibited advertisement campaign from the association module to the intermediate module.

In at least some embodiments, the method comprises omitting at least one specific restricted identifier in the results of the association, based on a flag associated with the at least one specific restricted identifier.

In some embodiments the steps of the method are performed in real time. In at least some embodiments, the targeting criterion comprises personally identifying information about a subscriber of the at least one service provider. In some embodiments, the targeting criterion is data that is correlatable with postal addresses.

In some embodiments, the targeting criterion is selected from the group consisting of: names, postal addresses, postal codes, e-mail addresses, network equipment identifiers, government-issued alphanumeric identification strings, privately-issued alphanumeric identification strings, behavioral profiles, website content profiles, administrative divisions, municipal districts, school districts, electoral districts, demographic market areas, neighborhood trading areas, geographic identifiers, and geographic area identifiers.

In at least some embodiments, the geographic area identifiers comprise at least one geographic center point, at least one inner radius defining an inner circular border and at least one outer radius defining an outer circular border of a geographical area that is between the inner circular border and the outer circular border when both the inner circular border and the outer circular border are centered on the at least one geographic center point. In some embodiments, the geographic area identifiers define polygonal vertices of a geographical area.

In at least some embodiments, the plurality of restricted identifiers comprises postal addresses. In some embodiments, the plurality of non-restricted identifiers is selected from the group consisting of: network addresses, Internet Protocol addresses, telephone numbers, and hash codes.

In some embodiments, the advertising module further accepts a first maximum bid amount associated with the advertisement identifier and at least one additional advertisement identifier with associated maximum bid amount and targeting criterion, and communicates the first maximum bid amount and the associated maximum bid amount to the intermediate module; and the intermediate module selects the advertisement identifier associated with the highest maximum bid amount when determining the advertisement identifier to associate with the plurality of non-restricted identifiers.

### DRAWINGS

For a better understanding of the various embodiments described herein, and to show more clearly how they may be carried into effect, reference will now be made, by way of example only, to the accompanying drawings which show at least one exemplary embodiment, and in which:

FIG. 1A is a block diagram of an advertising system in accordance with the preferred embodiment;

FIG. 1B is another block diagram of the advertising infrastructure of FIG. 1A;

FIG. 2 is a diagram illustrating the data structure of an exemplary embodiment of a change map for the advertising system of FIG. 1A;

FIG. 3 is a diagram illustrating the data structure of an exemplary embodiment of an individual address record for the advertising system of FIG. 1A;

FIG. 4 is a diagram illustrating the data structure of an exemplary embodiment of an advertiser account record for the advertising system of FIG. 1A;

FIG. 5 is an exemplary table of values for a sample custom demographic data set for the advertising system of FIG. 1A;

FIG. 6 is an exemplary table of values for a sample demographic area data set for the advertising system of FIG. 1A;

FIG. 7 is a schematic diagram of an exemplary embodiment of a web-based interface for the advertising system of FIG. 1A;

FIG. 8 is a schematic diagram of an exemplary embodiment of a sub-campaign target and presentation criteria selection screen for the advertising system of FIG. 1A;

FIG. 9 is a schematic diagram of an exemplary embodiment of a custom demographic configuration section screen for the advertising system of FIG. 1A;

FIG. 10 is a schematic diagram of an exemplary embodiment of a demographic area configuration section screen for the advertising system of FIG. 1A;

FIG. 11 is a schematic diagram of an exemplary embodiment of a presentation criteria selection tab screen for the advertising system of FIG. 1A;

FIGS. 12A and 12B are flowchart diagrams for the exemplary embodiment of a query answer compiler for the advertising system of FIG. 1A;

FIG. 13 is a diagram illustrating an exemplary query answer compiler data structure for the advertising system of FIG. 1A; and

FIG. 14 is a flowchart diagram for the exemplary embodiment of a rank engine for the advertising system of FIG. 1A.

The skilled person in the art will understand that the drawings, described below, are for illustration purposes only. The drawings are not intended to limit the scope of the applicants' teachings in anyway. Further, where considered appropriate, reference numerals may be repeated among the figures to indicate corresponding or analogous elements.

### DESCRIPTION OF VARIOUS EMBODIMENTS

It will be appreciated that numerous specific details are set forth in order to provide a thorough understanding of the exemplary embodiments described herein. However, it will be understood by those of ordinary skill in the art that the embodiments described herein may be practiced without these specific details. In other instances, well-known methods, procedures and components have not been described in detail so as not to obscure the embodiments described herein. Furthermore, this description is not to be considered as limiting the scope of the embodiments described herein in any way, but rather as merely describing the implementation of the various embodiments described herein.

The embodiments of the systems and methods described herein may be implemented in hardware or software, or a combination of both. However, preferably, these embodiments are implemented in computer programs executing on programmable computers each comprising at least one processor, a data storage system (including volatile and non-volatile memory and/or storage elements), and at least one communication interface. For example and without limitation, the programmable computers may be a server, network appliance, set-top box, embedded device, computer expansion module, personal computer, laptop, personal data assistant, and mobile telephone. Program code is applied to input data to perform the functions described herein and generate output information. The output information is applied to one or more output devices, in known fashion. In some embodiments, the communication interface may be a network communication interface. In embodiments where elements of the invention are combined, the communication interface may be a software communication interface, such as those for inter-process communication (IPC). In still other embodiments, there may be a combination of communication interfaces.

Each program is preferably implemented in a high level procedural or object oriented programming and/or scripting language to communicate with a computer system. However, the programs can be implemented in assembly or machine language, if desired. In any case, the language may be a compiled or interpreted language. Each such computer program is preferably stored on a storage media or a device (e.g. ROM or magnetic diskette) readable by a general or special purpose programmable computer, for configuring and operating the computer when the storage media or device is read by the computer to perform the procedures described herein. The inventive system may also be considered to be implemented as a computer-readable storage medium, configured with a computer program, where the storage medium so configured causes a computer to operate in a specific and predefined manner to perform the functions described herein.

Furthermore, the system, processes and methods of the described embodiments are capable of being distributed in a computer program product comprising a physical computer readable medium that bears computer usable instructions for one or more processors. The medium may be provided in various forms, including one or more diskettes, compact disks, tapes, chips, magnetic and electronic storage media, and the like. The computer useable instructions may also be in various forms, including compiled and non-compiled code.

Advertisers who wish to display advertisements in a web page may have a specific target audience in mind. Often, the target audience may be characterized by a particular geographic location. Accordingly, when choosing advertisements to embed in a web page, web servers may attempt to infer a client's physical location from the known IP address used to make a web browser request. However, because individual subscribers do not own their IP addresses, but rather are dynamically assigned IP addresses by a service provider, IP addresses are only loosely coupled with physical location or postal address. Generally, such inferences provide only coarse-grained determinations of location, for example the client's city, but not neighborhood or postal address.

Network service providers have more accurate information regarding the postal address associated with an IP address (e.g., subscriber's billing address). However, dissemination of personally identifying information about subscribers to third parties is typically restricted due to privacy laws, service agreements or for other reasons. Examples of such restricted identifiers may include names, identification numbers (both government- and privately-issued), telephone numbers, street and postal addresses, e-mail addresses, IP addresses (in some contexts), vehicle registration numbers, driver's license numbers, biometric data, credit information and other identity-related information. Conversely, other identifiers are non-restricted. For example, in the context of a web page request, the subscriber necessarily discloses an IP address as part of the request. Accordingly, this information comprises a non-restricted identifier for the purposes of fulfilling the web request. Other examples of non-restricted identifiers may include telephone numbers, age, gender or race, workplace, and sufficiently coarse-grained location of residence (e.g., city, county, state, etc.). In some embodiments, non-restricted identifiers that are considered sensitive information (e.g., where laws require such information to be anonymized) may be anonymized by, for example, applying a hash function to generate a hash code that is capable of distinguishing the sensitive information without necessarily revealing it.

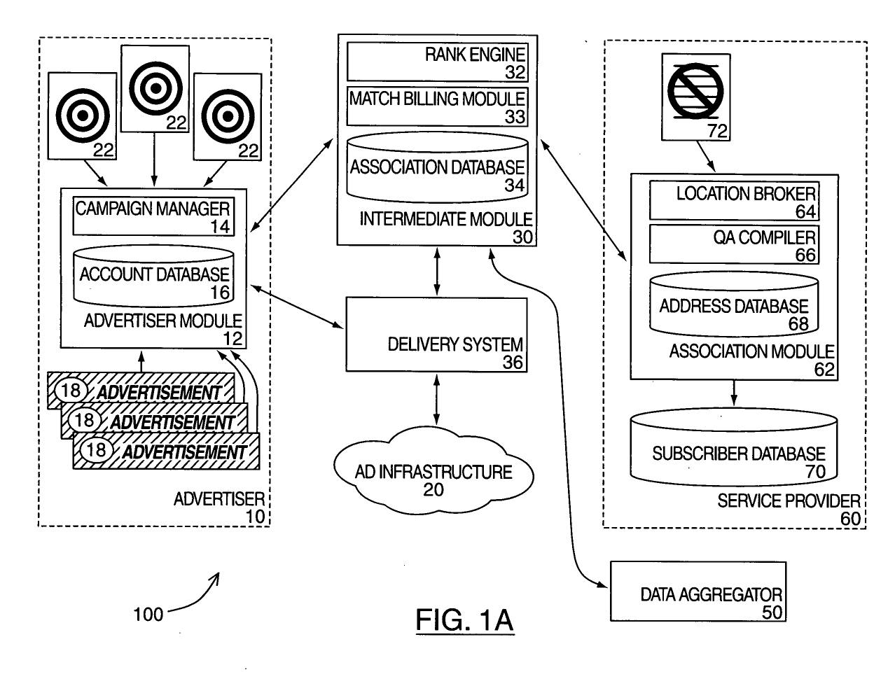

Reference is first made to FIG. 1A, which shows a general diagram of a distributed advertising system 100 according to one embodiment. Advertising system 100 comprises a query answer (QA) or intermediate module 30 and a delivery system 36 for advertisements in communication with each other over a network, such as the Internet. Delivery system 36 is in communication with advertising infrastructure 20. In some embodiments, delivery system 36 may be part of advertising infrastructure 20. Intermediate module 30 is also in communication with advertiser 10 and service provider 60. In some embodiments, intermediate module 30 may communicate with a plurality of advertisers 10 and service providers 60. In some embodiments, intermediate module 30 may also communicate with at least one data aggregator 50. In alternative embodiments, the communications medium may be a network other than the Internet including, for example, a local area network, a wide area network, a wireless network, a proprietary network, etc. In still other embodiments, delivery system 36 may be integrated into intermediate module 30.

Advertiser 10 is a party promoting goods and/or services, preferably via the Internet. Preferably, advertiser 10 is provided access to an advertiser module 12, which has an account database 16 and a campaign manager 14, the latter for accepting one or more advertisements 18 and targeting criteria 22 associated with each of the advertisements 18. Campaign manager 14 may also accept other data, such as custom demographic data. For example, a neighborhood restaurant may wish to target homes within a certain radius of the restaurant. Alternatively, a retail store may have a list of postal addresses obtained through a direct relationship or its own records, which it may already use for direct marketing purposes.

Accordingly, advertiser 10 may configure advertising campaigns by specifying appropriate target criteria 22 and providing associated advertisements 18. Targeting criteria 22 are data that can be linked to or translated into a physical location or plurality of physical locations, preferably in the form of postal addresses. Such data may include postal addresses (such as a home, apartment, office building, or any other physical geographical location), postal or ZIP codes and their enhancements (e.g., ZIP+4), existing neighborhood trading areas (NTAs), demographic market areas (DMAs), latitude/longitude coordinates identifying a geographic location, coordinates (e.g., latitude/longitude or a postal address) and inner and outer radii defining a geographical area in a roughly circular band centered about the coordinates, coordinates (e.g., latitude/longitude or postal addresses) defining a polygon-shaped area, GPS data, government-issued identification numbers (e.g., driver's license number, social security number, etc.), privately-issued identification numbers (e.g., rewards program membership number), demographic data (e.g., median age in a neighborhood), fuel prices data, weather data, real estate data, census data (e.g., median income for a neighborhood), credit scores (e.g., neighborhood level), electoral districts, school districts, etc. In alternative embodiments, advertiser module 12 may be integrated into intermediate module 30.

Linking or translation of targeting criteria 22 to physical locations may be direct, as in the case of postal addresses, or may require intermediate data from another database or third party to determine its association with a postal address, as in the case of driver's license numbers. Accordingly, targeting data 22 may be any data that is capable of being mapped or translated to one or more physical addresses. In some cases, the mapping or translation may occur in real-time. For example, in the case of fuel prices data, targeting criteria 22 may specify that postal addresses in neighborhoods where the average price of gasoline is above a certain threshold should be targeted. If fuel prices data is available in real-time, the targeted neighborhoods may change in real-time to reflect changes in fuel prices.

Service provider 60 operates a communication service (e.g., Internet access provider) and, accordingly, has accurate and real-time knowledge of the current mailing or billing address (which preferably correspond to postal addresses) and current IP address of each subscriber to the communications service it operates. In many cases, service provider 60 is mandated by law to maintain accurate and real-time address information for the provision of emergency services (e.g., enhanced 911 service). Service provider 60 preferably has a subscriber database 70. Subscriber database 70 contains detailed subscriber information, for example, name, billing address and other data known about the subscriber. Some of the subscriber data may be private.

In some embodiments, service provider 60 may provide a prohibited advertiser list 72 to association module 62 and subsequently to intermediate module 30. Accordingly, prohibited advertising campaigns associated with advertisers appearing in prohibited advertising list 72 will be ignored and removed from the available advertising campaigns provided to service provider 60 when targeting subscribers of service provider 60.

Likewise, in some embodiments, subscribers may opt out of participation in the advertising system. Accordingly, an opt-out flag may be set on the subscriber's record in subscriber database 70. Subsequently, when data from subscriber database 70 is provided to association module 62, records for which the opt-out flag is set will be omitted and the subscriber's data will not be shared or even revealed to exist.

In some embodiments, data aggregator 50 may also have subscriber data, obtained independently. For example, data aggregator 50 may operate network optimization or traffic management services, possibly in conjunction with service provider 60, which cause it to aggregate its own subscriber data. Alternately, data aggregator 50 may be a third-party market researcher that partners with website publishers to accumulate statistical data about web browsing habits. Accordingly, the operator of intermediate module 30 may contract with data aggregator 50 to obtain access to data aggregator 50 data.

Intermediate module 30, advertiser module 12 and association module 62 may comprise one or more special purpose or general-purpose computers or servers, each of which may include, but is not limited to, one or more processors, memories, storage devices, input/output devices and a network interface. For the purposes of explanation, the terms ‘computer’ and ‘server’ may be interchangeable in accordance with the above description. In some embodiments, modules 30, 12 and 62 may be implemented as computer software in the form of computer readable code executed in memory by processors on one or more of the computers or servers contemplated above. Although the modules are illustrated in FIG. 1A as separate components, it should be understood that various modules and/or the components thereof could be combined into a single computer or server, or implemented across multiple computers or servers all connected via a communications medium (such as the Internet).

Referring now to FIG. 1B, a diagram of advertising infrastructure 20, including advertising delivery system 36, is shown. Subscriber 110 is preferably a subscriber of service provider 60 and resides in a physical location that is part of the target audience for the advertising campaigns created by at least one advertiser 10. Preferably, subscriber 110 is an Internet subscriber executing web browser client programs (e.g., Microsoft Internet Explorer or Mozilla Firefox) on a computer to browse the World-Wide Web. A website publisher may embed ad requests within web pages. Upon encountering such an embedded ad request, subscriber's web browser will forward the ad request to delivery system 36 for fulfillment. Delivery system 36 returns appropriate advertisements to the web browser of subscriber 110, which are embedded within the web page for display to the subscriber. In alternative embodiments, subscriber 110 may be another type of subscriber such as, cable TV subscriber or wireless network subscriber.

Publisher 120 controls the advertisement space presented to subscriber 110. Publisher 120 may be an online web site owner that makes online web sites accessible to the computer of subscriber 110 via web servers over the Internet. The advertisement space may be space reserved in a web page (e.g., reserved space on a page layout, pop-up windows, etc.) for images, video, audio, text and interactive content. It will be understood that advertisement spaces are not limited to Internet web pages and that publisher 120 may publish media other than Internet web pages (e.g., television, video games, mobile ads, etc.).

In some embodiments, advertising network 130 interfaces between at least one publisher 120, at least one advertiser 10, delivery system 36 and intermediate module 30. Advertising network 130 is an entity that represents a plurality of advertisers 10 and/or publishers 120. Advertising network 130 may comprise a plurality of servers including, but not limited to, its own delivery system 36. In some embodiments, a publisher 120 may also have its own delivery system 36. Preferably, advertising network 130 communicates with intermediate module 30 over a network, allowing at least one advertiser 10 that it represents to create advertising campaigns and sub-campaigns within intermediate module 30. A delivery system 36 may send ad requests to intermediate module 30 whereupon intermediate module 30 will initiate a real-time automated bidding process and return an appropriate advertisement identifier to the advertising network 130 or publisher 120 for fulfillment from advertisements stored in the delivery system 36 repository to the subscriber 110.

Delivery system 36 preferably comprises an ad request handler 150, an advertisement storage repository 154, and a tracking/billing module 152. Ad request handler 150 accepts advertisement requests, sends the subscriber 110 IP address to intermediate module 30 to initiate a real-time automated bidding process and, based on the outcome of the bidding process, returns the appropriate advertisement identifier. Ad requests may be received from subscriber 110, publisher 120 or advertising network 130. However, in some embodiments, delivery system 36 may receive and respond to ad requests from any other computer or server. In some embodiments, delivery system 36 may also send the advertisement from advertisement storage repository 154. Advertisement storage repository 154 stores data files associated with advertisements (e.g., images, video, etc.), each referenced by a unique advertisement identifier (“creative ID”). Advertisement storage repository 154 may be located at delivery system 36, advertising network 130, publisher 120 or elsewhere where it is accessible over a network.

Tracking/billing module 152 may perform click-through tracking, ad impression tracking, accounting, billing and recordkeeping functions. Furthermore, tracking/billing module 152 may determine other advertising metrics, fulfillment success rates (e.g., failed download rates), number of requests from a network, etc. Tracking/billing module 152 may iterate through accumulated metrics to generate reports for service providers, advertisers and publishers.

Referring now to both FIGS. 1A and 1B, intermediate module 30 preferably has a rank engine 32, a match billing module 33 and an association database 34. Association module 62 preferably has a location broker 64, an address database 68 and a query answer (QA) compiler 66. Advertiser module 12 preferably has a campaign manager 14 and an account database 16.

Match billing module 33 may perform additional billing tasks, such as tracking the number of matches generated, bidding results and associated advertising campaigns. In embodiments where delivery system 36 is integrated into intermediate module 30, match billing module 33 may be integrated with tracking/billing module 152.

Location broker 64, campaign manager 14, QA compiler 66 and the rank engine 32 preferably operate as computer software processes. Address database 68, account database 16 and association database 34 are preferably data storage structures that may be implemented using a relational database system. Each of the components may be combined into a single process or server, or implemented across multiple servers all connected via a communications medium, such as the Internet or a private network.

Location broker 64 may take data inputs from service provider 60 and data aggregator 50. Preferably, service provider 60 and data aggregator 50 provide IP address to postal address mappings to location broker 64. Location broker 64 may validate postal addresses for compliance with chosen standards, such as postal standards, and transfer the IP address to postal address mappings into address database 68, preferably in a background operation. Accordingly, service provider 60 and data aggregator 50 may provide data in a bulk transfer, preferably at least daily in order to ensure the accuracy of the data. Alternatively, data may be provided on a continuous or even real-time basis, depending on the needs of service provider 60 or data aggregator 50.

Campaign manager 14 may take data inputs (e.g., target criteria, advertisement files, custom demographic data) from advertiser 10 and advertising network 130 to configure advertising campaigns. For each advertising campaign, campaign manager 14 computes a unique identifier, which will be used by other modules (e.g., intermediate module) to reference the campaign without directly identifying the advertiser or the specifics of the advertising campaign. Campaign manager 14 further computes postal addresses satisfying the target criteria. For example, if the target criteria are a center address and inner and outer radii of a target zone, campaign manager computes the postal addresses falling between the inner and outer boundaries specified by the radii, when centered around the center address. Campaign manager 14 transfers the configured advertising campaign information to account database 16. Likewise, campaign manager 14 transfers advertisements (“creatives”) to ad storage repository 154 of delivery system 36. Account database 16 may also receive periodic data inputs from tracking/billing module 152 of delivery system 36.

Preferably, in a background operation, advertiser module 12 sends QA compiler 66 advertising campaign data from account database 16 comprising unique campaign identifiers and associated postal addresses for determining matches in address database 68 and for use in rank engine 32. In some embodiments, no further metrics are disclosed. Accordingly, the identities of advertisers and the specifics of their advertising campaigns are not disclosed to intermediate module 30; only the postal addresses or an area of postal addresses satisfying a particular unique campaign identifier are known to intermediate module 30. Rank engine 32 may be a real-time process, which takes data inputs from ad request handler 150 of delivery system 36 in the form of an ad request, queries address database 68 and performs a real-time automated bidding process in order to determine an advertisement identifier to return to delivery system 36. Each of the above components is described in more detail below.

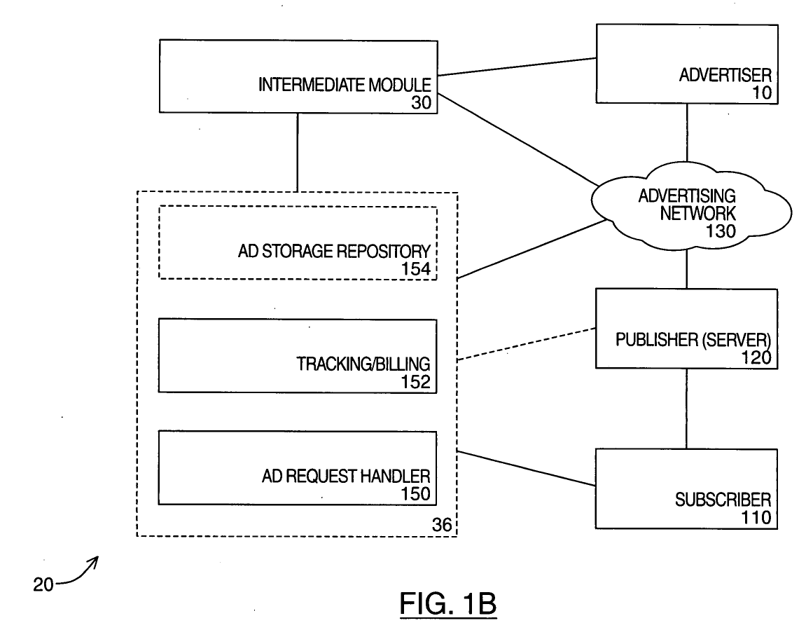

Referring now to FIG. 2, there is shown an exemplary embodiment of a change map 200 that is stored in the local memory of location broker 64, and created to enable the transfer of mapping data to address database 68. Location broker 64 compares the data previously received from service provider 60 or data aggregator 50 with the most recent data received. Change map 200 is a temporary data structure created locally by location broker 64 that represents a list of change directives for address database 68. Preferably, each entry in change map 200 is comprised of at least an index 202, a postal address 204, an existing IP address 206 and a new IP address 208. Index 202 represents the order of operation for the location broker 64, beginning from 0 and progressively iterating by 1 until the final entry n is reached. Postal address 204 may be a known postal address in address database 68 or a new postal address to be added to address database 68. Existing IP address 206 corresponds to the previous IP address associated with a particular postal address 204 in address database 68. New IP address 208 corresponds to the most recent IP address associated with a postal address by service provider 60. Accordingly, the association of postal address 204, existing IP address 206 and new IP address 208 is representative of additions, deletions or changes to address database 68.

In operation, if existing IP address 206 is empty or null and there is provided a corresponding new IP address 208, location broker 64 adds the corresponding postal address 204 to address database 68. Similarly, if existing IP address 206 is not equal to null and the corresponding new IP address 208 is equal to null, location broker 64 deletes the existing IP address 206 and associated postal address 204 from address database 68. If both existing IP address 206 and new IP address 208 are not equal to null, location broker 64 changes the existing IP address 206 in address database 68 to reflect new IP address 208.

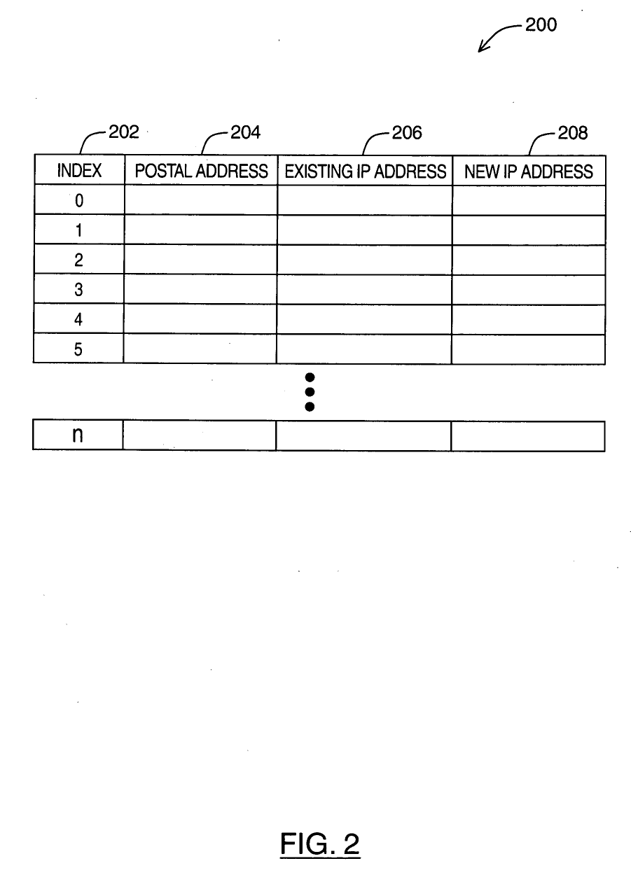

Referring now to FIG. 3, there is shown a diagram of the data structure 399 for an exemplary embodiment of an individual address record 300 of the address record table within address database 68. First, address record 300 contains a unique index 302 and a postal address 304 comprising, for example, street number, street name, zip/postal code, city, state/province and country. A separate address record 300 exists for each postal address known to association module 62, and the unique index 302 facilitates the querying of each address record table within the address database 68. Preferably, location broker 64 may also maintain a second table in address database 68 to facilitate the lookup of IP addresses in the address record table. This second table provides a mapping between an IP address and the corresponding unique index 302. Accordingly, when location broker 64 adds a new postal address to address database 68, a new address data record 300 is created with the new postal address 304.

Further, IP address 306 is a list of zero or more IP addresses that may be used to correlate an Internet ad request to a postal address and ultimately to an advertisement. Location broker 64 may add, delete or change IP address 306 as described with reference to FIG. 2 above.

Latitude 308, longitude 310, neighborhood code 312, city code 314, country code 316, and Internet Service Provider (ISP) code 318 of address record 300 are each calculated based on the postal address 304 and IP address 306. Preferably, address record 300 does not contain the name of the subscriber located at the postal address 304 or other privacy-related information.

Advertising information section 320 of address record 300 contains advertising information related to the postal address 304 that is used in the real-time automated bidding process, which will be described below. Advertising information section 320 is preferably organized into zero or more sub-campaigns 330. Advertising information section 320 is populated by identifying advertising campaign target criteria that is satisfied by data contained in the address record 300.

Each sub-campaign 330 has target criteria, an associated bid amount and contains index information to conduct the real-time automated bidding process. Preferably, each sub-campaign 330 comprises a sub-campaign ID 350, a target criteria section 352, a bid amount 354, a creative section 356, a frequency 358, an ad network ID 360 and an approximate coverage 362.

Sub-campaign ID 350 corresponds to an advertiser's sub-campaign within account database 16. Target criteria section 352 may reference any behavioral criteria and any website content criteria provided by a third party, such as data aggregator 50. Behavioral data may include frequently visited websites and website content criteria may refer to frequently visited classes of websites (e.g., sports, technology, etc.). Preferably, target criteria section 352 is in the form of an equation that when evaluated returns a true (1) or false (0) value.

Bid amount 354 may be a money amount specified by an advertiser for any ad request that matches target criteria section 354. When an advertiser's advertisement is selected to fulfill the ad request, bid amount 354 may be taken from the advertiser's prepaid account or the advertiser may be invoiced. Creative section 356 is a list of one or more advertisements (“creatives”) that may be returned if the sub-campaign is selected to fulfill the ad request. Optionally, there may be a plurality of creatives associated with each sub-campaign.

Daily frequency 358 is an inventory management tool that specifies a maximum number of times a particular sub-campaign may be presented to a particular postal address 304 within a 24-hour period. Ad network ID 360 specifies an identification code that uniquely identifies an ad network 130. If the sub-campaign identified by sub-campaign ID 350 does not require an ad network ID, ad network ID 360 may be set to a default ad network ID reserved for advertising system 100. Alternatively, ad network ID 360 may be null. Approximate coverage 362 specifies an estimated number of postal addresses associated with the target criteria of the sub-campaign that matches the sub-campaign ID 350 within account database 16. Accordingly, in some embodiments, approximate coverage 362 may be used in the real-time automated bidding process.

Access to account information stored in account database 16 may be restricted to users having a valid login username and password. For example, only those users with an account record in account database 16 may be provided with a valid login username and password. Preferably, there are multiple different types of account records stored within account database 16, such as administrator account records, ad network administrator account records and advertiser account records. Each of the different types of account records may specify a username and password. In the alternative, or in addition to the above, access may be restricted by other means, including cryptographic key, biometric identification or other authentication schemes known in the art.

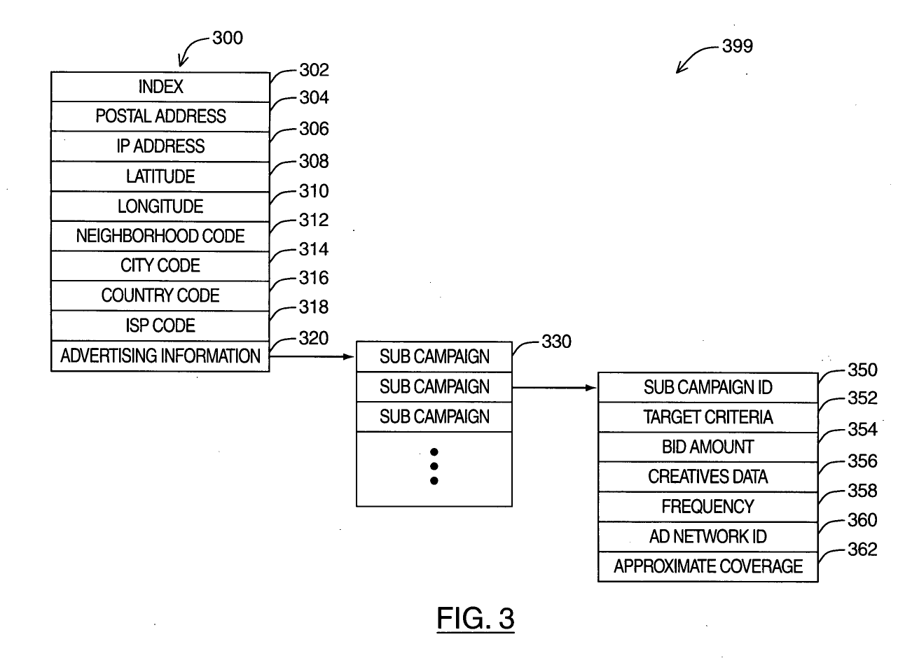

Referring now to FIG. 4, there is shown a diagram of the data structure 499 for an exemplary embodiment of an advertiser account record 400 in account database 16. First, advertiser account record 400 contains username 402 and password 404, which may be used for authenticating the advertiser, to enable the advertiser to access and make changes to their corresponding account record 400. Advertiser account record 400 contains contact information 406 comprising, e.g., contact name, company name, street address, telephone number and email address, to enable contacting the advertiser as necessary. Advertiser account record 400 also contains billing information 408, for example current account balance, previous transactions and credit card information. Billing information 408 may be accessed and modified by delivery system 36. If a particular advertiser account record 400 is for an advertiser associated with an ad network, ad network ID 410 contains the identification code that uniquely identifies the ad network. Alternatively, the ad network ID 410 may be set to a default ad network ID reserved for advertising system 100. In still another alternative, ad network ID 360 may be null.

Creative data section 412 may be accessed when an advertiser configures the presentation criteria of an advertising campaign. Creative data section 412 corresponds to a list of zero or more creative data (e.g., advertisements) associated with the advertiser's account. The advertiser may provide creative data (such as image files, video files, audio files and text files) to campaign manager 14, either one at a time or in bulk. Preferably, campaign manager stores the creative data in external storage and generates a unique creative ID for each element of creative data. Accordingly, each element of creative data is associated with the advertiser's account in creative data section 412 by the creative ID.

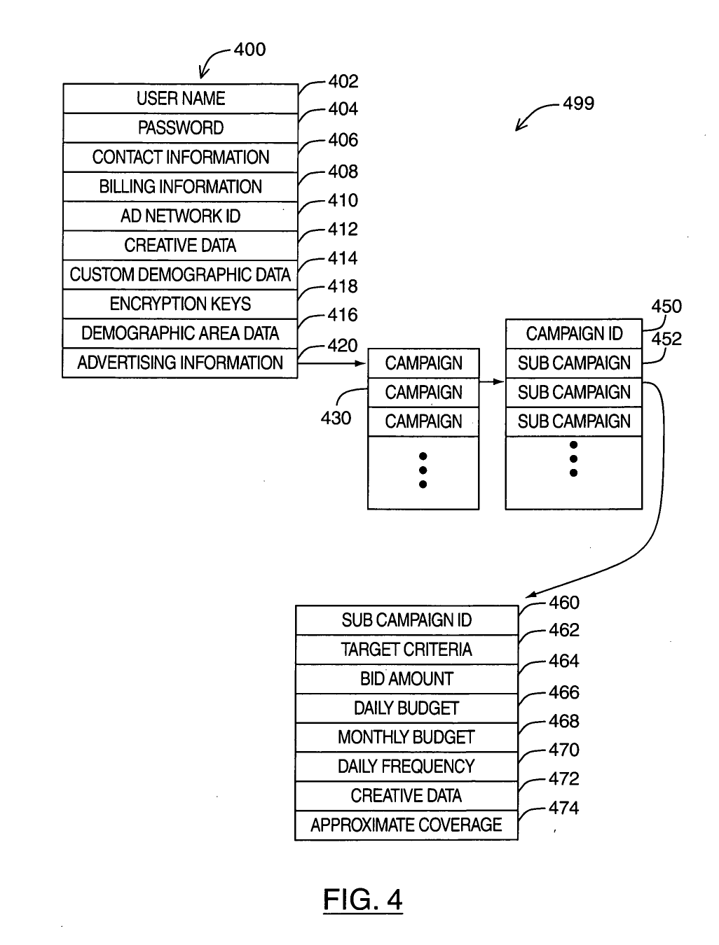

Custom demographic data section 414 corresponds to a list of zero or more custom demographic data sets associated with an advertiser's account. The advertiser may specify multiple custom demographic data sets using campaign manager 14. Data in custom demographic data section 414 is specified by an advertiser when configuring target criteria for an advertising campaign and comprises targeting data known to the advertiser. Accordingly, as exemplified in FIG. 5, each custom demographic data set may comprise a set of postal addresses, for example from an advertiser's mailing list. For example, the set of postal addresses may represent all homes currently for sale within a region, while another set of postal addresses may represent all the customers that have made purchases from the advertiser in the past 6 months.

In addition, each postal address in the custom demographic data set may be accompanied by attributes 500 (FIG. 5). Each one of attributes 500 may be used as a Boolean targeting variable, which may be used by the advertiser when specifying the targeting criteria of an advertising campaign. That is, every postal address within the set either has the attribute or does not have the attribute. Accordingly, an advertiser may target addresses within the set by selecting for addresses that have, or do not have, a specific attribute. An example of these attributes 500 may be the type of services a postal address currently subscribes to (e.g. cable television, mobile phone and home phone). Preferably, each custom demographic data set specified by an advertiser is assigned a target variable name (preferably unique to the advertiser account data record 400) and a custom demographic data set ID (preferably unique to system 100).

Preferably, there is a minimum threshold for the number of postal addresses within a custom demographic set. This limits the ability of a third party advertiser to infer the IP address to postal address mappings or other unique identifying information for a particular subscriber 110. Similarly, advertiser module 12 may perform verification checks for all custom demographic data sets in the custom demographic data 414 section for each advertiser account record 400. In particular, advertiser module 12 may enforce minimum and maximum limits on overlap between custom demographic data sets.

Encryption keys section 418 of advertiser account record 400 corresponds to a list of zero or more encryption keys. Custom demographic data sets uploaded by an advertiser may include private or proprietary information regarding customers or customer attributes. Accordingly, the advertiser may wish to safeguard this information and therefore may have the option to encrypt specific fields and attributes 500 before storing the demographic data set. To enable decryption of the fields when needed by system 100, advertisers store encryption keys within encryption keys section 418 of their advertising account record 400. In another embodiment, encryption keys may be stored in another database or database table, which may be located on a different server.

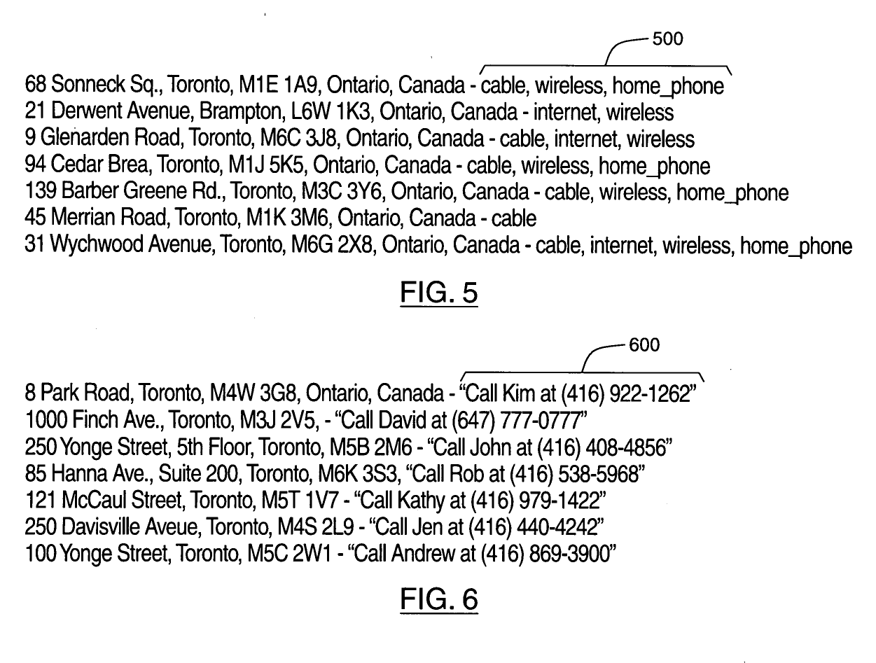

Demographic area data section 416 corresponds to a list of zero or more demographic area data sets associated with an advertiser's account. The advertiser may provide multiple demographic area data sets using campaign manager 14. In one embodiment, data in demographic area data section 416 is specified by an advertiser when configuring target criteria for an advertising campaign and comprises one or more center points of target regions. Accordingly, as exemplified in FIG. 6, the demographic area data sets comprise sets of postal addresses to be used as the center points (“center addresses”) of their respective circular target bands. Using this set of center addresses, an advertiser may create many locally-specific advertising campaigns with one target variable associated with the demographic area data section 416.

For example, a national fitness center chain may want to advertise a special promotion to any subscriber within a 1-mile radius of any of their gyms. Rather than create many different advertising sub-campaigns for each gym, the advertiser can upload a demographic area data set that contains the postal address of each of their gyms and the campaign manager may create one or more sub-campaigns by referencing a single target variable containing the demographic area data set. In cases where demographic areas overlap (e.g., because two gyms are within 1 mile of each other), the campaign manager may choose the nearest radial center point for each postal address that falls within both areas.

Each center address, such as a postal address, in the demographic area data set may also include a custom message 600 (FIG. 6) to be used in the advertisement configured in that advertising campaign, which references the demographic area data set. For example, the national chain may accompany each gym address in the demographic area data set with a sales representative's name and phone number as the custom message 600. Thus, the advertisement displayed to a subscriber 110 will include the local sales representative's name and phone number, making the ad much more relevant to the subscriber 110. Preferably, each demographic area data set is assigned a target variable name (preferably unique to the advertiser's account data record 400) and a demographic data set ID (preferably unique to system 100).

Advertising information section 420 of advertising account record 400 contains information used in the real-time automated bidding process and may be organized as zero or more campaigns 430. Preferably, each campaign 430 has a campaign ID 450 and one or more sub-campaigns 452. The hierarchy of campaigns and sub-campaigns aids advertisers to organize their advertising efforts, but need not be provided in other embodiments. Accordingly, in other embodiments, advertising information section 420 does not have sub-campaigns 450.

Each sub-campaign 452 has target criteria, an associated bid amount and contains index information to conduct the real-time automated bidding process. A sub-campaign 452 may correspond to a sub-campaign 330 in account database 16. Preferably, each sub-campaign 452 comprises a sub-campaign ID 460, a target criteria section 462, a bid amount 464, a daily budget 466, a monthly budget 468, a daily frequency 470, a creative section 472 and an approximate coverage 474. In one embodiment, the sub-campaign ID 460 is a unique identifier within system 100.

Target criteria section 452 preferably reference custom demographic data sets, demographic area data sets, neighborhood codes, city codes, ISP codes, country codes, behavioral criteria and website content criteria. Target criteria section 452 may be formulated as an equation that, when evaluated, returns a true (1) or false (0) value.

Bid amount 464 may be a money amount specified by an advertiser for any ad request that matches target criteria section 462. When an advertiser's advertisement is selected to fulfill the ad request, bid amount 464 may be taken from the advertiser's prepaid account or the advertiser may be invoiced. Daily budget 466 represents a daily limit on bid expenditures for a particular the sub-campaign. Similarly, monthly budget 468 represents a monthly limit on expenditures. Daily frequency 470 specifies a maximum number of times a particular sub-campaign may be presented to a particular postal address within a 24-hour period. Creative section 472 is a list of one or more advertisements (creatives) that may be returned if the sub-campaign is selected to fulfill the ad request. Preferably, there is a plurality of creatives associated with each sub-campaign. Approximate coverage 474 specifies an estimated number of postal addresses associated with target criteria section 462. Accordingly, in some embodiments, approximate coverage 474 may be used in the real-time automated bidding process.

Using campaign manager 14, advertisers may perform a number of tasks related to their accounts stored within account database 16, such as campaign and sub-campaign management. The advertiser may select from the advertising campaign section to create a new or edit an existing campaign, as well as view an overview of all campaign details, including sub-campaigns and associated statistics. Preferably, the advertiser is given the opportunity to review any changes before they are finalized in the advertiser's account record. In other embodiments, the advertiser may make live changes in the account database 16. It will be appreciated that advertisers may delegate the performance of tasks relating to campaign manager 14 to other parties. Likewise, administrators and other users may also interact with campaign manager 14. Accordingly, references to advertisers herein refer to all parties who may be authorized to manage an advertising campaign, including provision of advertisements and target criteria.

Campaign manager 14 may also have an advertising campaign section, which enables the advertiser to provide creative data, custom demographic data sets and/or demographic area data sets. Campaign manager 14 assigns unique creative IDs to data provided by the advertiser. In one embodiment, campaign manager 14 stores creative data in the ad storage repository 154 (e.g., in the storage) of delivery system 36, referenced by its unique creative ID, for quick retrieval. In another embodiment, campaign manager 14 may store creative data on a storage device within intermediate module 30. Likewise, it will be appreciated that creative data may be stored in any persistent storage device internal or external to system 100, as long as intermediate module 30 and delivery system 36 may access the storage.

Upon provision of a custom demographic data set or demographic area data set to campaign manager 14, the data set may be assigned a target variable name (preferably unique to the advertiser's account record) by the advertiser and a custom data set ID (preferably unique to system 100) by campaign manager 14. The advertiser may also choose to encrypt the data set with a cryptographic encryption key. Once encrypted, the attributes and target variable name of the data set will be displayed by campaign manager 14 in encrypted format. To retrieve the original data, a user must provide a decryption key to campaign manager 14.

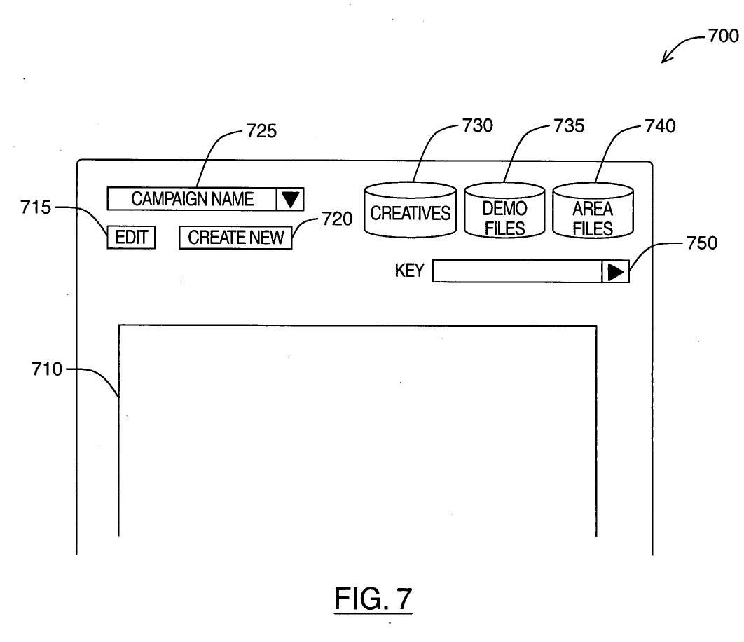

Referring now to FIG. 7, there is shown a schematic drawing of a web-based interface according to a preferred embodiment. Campaign manager 14 preferably has a web-based interface 700 accessible by the advertiser via the Internet. Using web interface 700, an advertiser may select a campaign via drop down menu 725, edit present campaign details using edit button 715, or create a new campaign using new button 720. Main window viewer 710 displays a summary of campaign details, including sub-campaigns and associated statistics. The advertiser may also provide creative data by clicking upload icon 730, custom demographic data by clicking custom demographic data icon 735, or demographic area files by clicking demographic area data icon 740. To view any encrypted data sets in clear text while logged into web interface 700, the advertiser may enter corresponding encryption keys into key area 750.

Advertisers may create a new sub-campaign or edit an existing sub-campaign from the advertising campaign section or sub-campaign section of web interface 700. As with the advertising campaign section, the sub-campaign section enables an advertiser to upload creative data, custom demographic data sets, demographic area data sets, and enter encryption keys in order to view the data sets in clear text. The sub-campaign section of web interface 700 also allows an advertiser to select the target and presentation criteria for the advertisement. The advertiser may select targeting criteria such as custom demographic data sets, demographic area data sets, neighborhood codes, city codes, ISP codes, country codes, behavioral data and website content data.

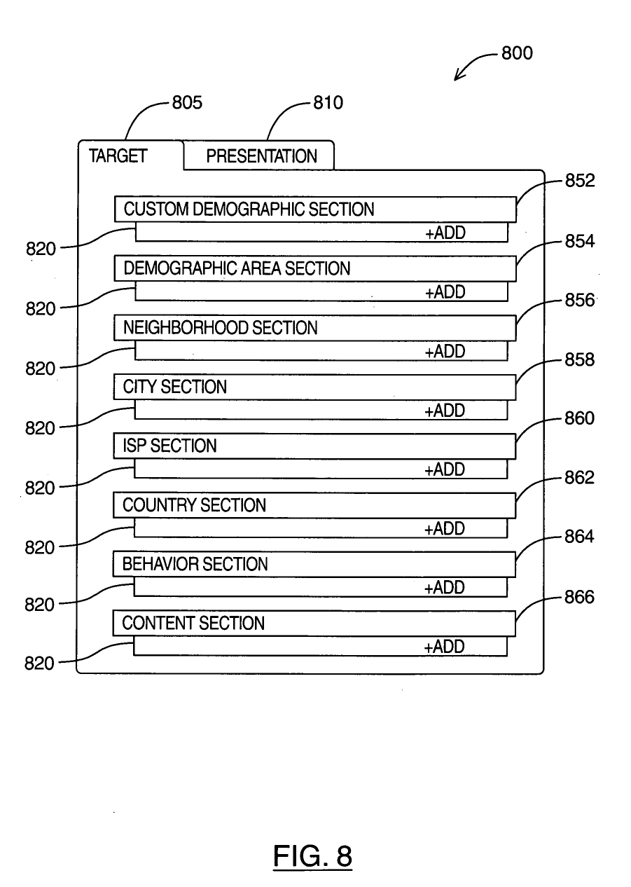

Referring now to FIG. 8, there is shown a schematic view of the sub-campaign target and presentation criteria selection screen 800 displayed to advertisers according to one exemplary embodiment. An advertiser may choose from the target criteria selection tab 805 or from the presentation criteria selection tab 810. From target criteria selection tab 805, there are preferably eight configuration sections: custom demographic section 852, demographic area section 854, neighborhood section 856, city section 858, ISP section 860, country section 862, behavioral section 864 and website content section 866. Advertisers may configure any of the target criteria sections by clicking on the ‘+ADD’ link 820.

Custom demographic target selection 852 within the sub-campaign section in web interface 700 corresponds to the custom demographic data sets associated with the advertiser's account record in the account database 16. An advertiser may configure the circumstances under which an ad request meets the criteria of a custom demographic data set, preferably by referencing a target variable name associated with the custom demographic data set and specifying whether positive matches or negative matches are desired. For a “positive match”, an ad request is evaluated against each postal address within a custom demographic data set. A true (1) value indicating a positive match is returned if the ad request matches any of the postal addresses within the custom demographic data set, and a false (0) value indicating no matches is returned if the ad request does not match any of the postal addresses. Conversely, for a “negative match”, an ad request is also evaluated against each postal address within a custom demographic data set. A true (1) value indicating a negative match is returned if the ad request does not match any of the postal addresses within the custom demographic data set, and a false (0) value indicating one or more matches is returned if the ad request matches any of the postal addresses. Where a custom demographic data set has additional attributes, the advertiser may select for positive or negative matches based on attributes associated with the custom demographic data set.

Demographic area target selection 854 within the sub-campaign section in web interface 700 corresponds to the demographic area data sets associated with the advertiser's account record in the account database 16. For the campaign or sub-campaign, an advertiser may select to provide an advertisement if an ad request is between a given inner radius and outer radius of any of the center addresses within the demographic area data set. It will be appreciated that by specifying a zero inner radius, a circular area defined by the center address and outer radius may instead be targeted. A true (1) value is returned if the ad request falls within a circular band as defined by the inner radius and outer radius, using any of the center addresses within the demographic area data set, otherwise a false (0) is returned.

Neighborhood target selection 856 within the sub-campaign section in web interface 700 enables advertisers to select a target neighborhood code from a neighborhood database stored by advertiser module 12 or externally. Accordingly, advertisers may specify that an advertising campaign should be provided to one or more neighborhood codes. Conversely, advertisers may specify that an advertising campaign should not be provided to one or more neighborhood codes.

City target selection 858 within the sub-campaign section in web interface 700 enables advertisers to select a target city code from a city database stored by advertiser module 12 or externally. Accordingly, advertisers may specify that an advertising campaign should be provided to one or more city codes. Conversely, advertisers may specify that an advertising campaign should not be provided to one or more city codes.

ISP target selection 860 within the sub-campaign section in web interface 700 enables advertisers to select a target ISP code from an ISP database stored by advertiser module 12 or externally. Accordingly, advertisers may specify that an advertising campaign should be provided to one or more ISP codes. Conversely, advertisers may specify that an advertising campaign should not be provided to one or more ISP codes.

Country target selection 862 within the sub-campaign section in web interface 700 enables advertisers to select a target country code from a country database stored by advertiser module 12 or externally. Accordingly, advertisers may specify that an advertising campaign should be provided to one or more country codes. Conversely, advertisers may specify that an advertising campaign should not be provided to one or more country codes.

Behavioral target selection 864 within the sub-campaign section in web interface 700 enables advertisers to select a behavior code from a behavioral database stored by advertiser module 12 or externally (e.g., by a data aggregator). Accordingly, advertisers may specify that an advertising campaign should be provided to one or more behavior codes. Conversely, advertisers may specify that an advertising campaign should not be provided to one or more behavior codes.

Website content target selection 866 within the sub-campaign section in web interface 700 enables advertisers to select a target website content type. For example, advertisers may choose to target websites dedicated to sports, fashion, automobiles, etc. Accordingly, advertisers may specify that an advertising campaign should be provided to one or more website content types. Conversely, advertisers may specify that an advertising campaign should not be provided to one or more website content types.

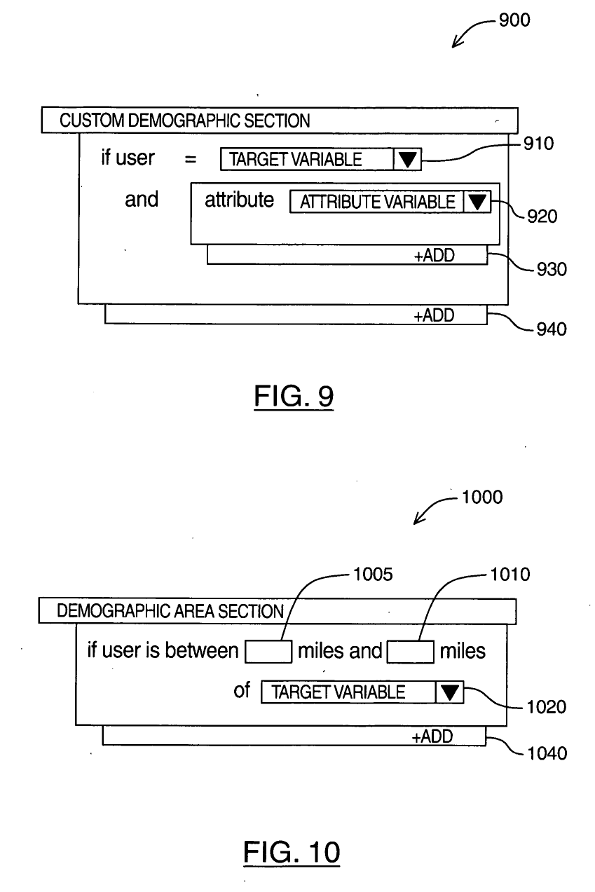

Referring now to FIG. 9, there is shown a schematic view of the custom demographic configuration section screen 900 displayed to advertisers according to one exemplary embodiment. A custom demographic data set may be selected from drop down menu 910, which preferably displays custom demographic data set target variable names. If attributes exist, any attributes associated with the custom demographic data set may also be selected from drop down menu 920. Additional or alternative attributes may be added by clicking ‘+ADD’ link 930. Likewise, additional or alternative custom demographic data sets may be added by clicking ‘+ADD’ link 940.

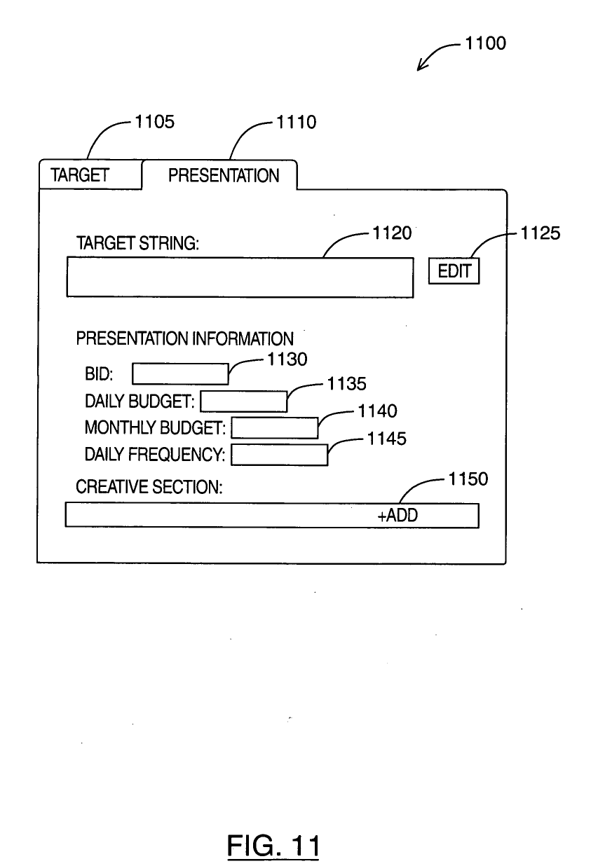

Referring now to FIG. 10, there is shown a schematic view of the demographic area configuration section screen 1000 displayed to advertisers according to one exemplary embodiment. An inner radius 1005, an outer radius 1010 and a demographic area data set may be selected from the drop down menu 1020, which preferably displays demographic data set target variable names. Additional or alternative demographic area data sets may be added by clicking ‘+ADD’ link 1040.

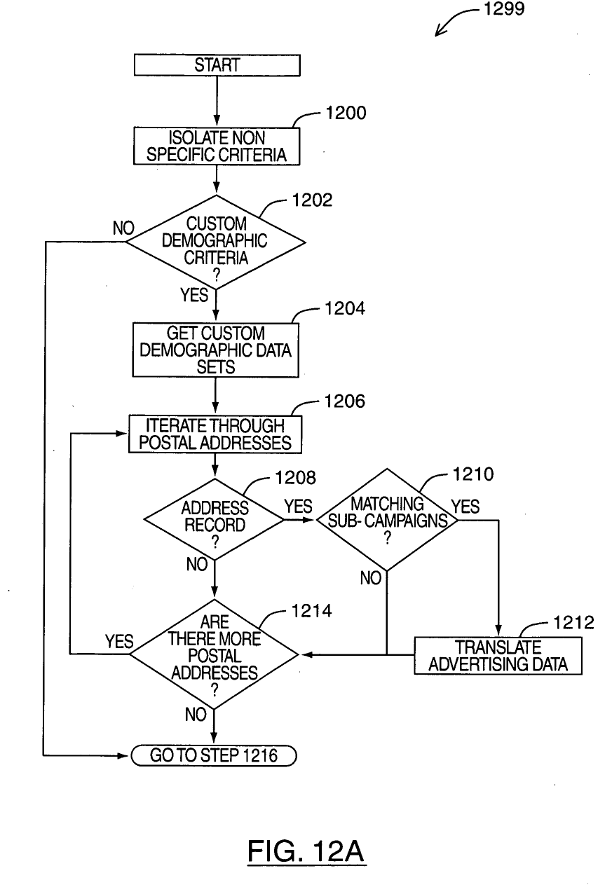

Referring now to FIG. 11, there is shown a schematic view of the presentation criteria selection tab screen 1100 displayed to advertisers according to one exemplary embodiment. Within presentation criteria selection tab 810, target criteria from the target criteria selection tab 805 are converted into an algorithmic or programmatic code and displayed as target string 1120. The string may be edited directly in target string 1120 text box, or edited by clicking edit button 1125 and returning to target criteria selection tab 805. Furthermore, bid amount 1130, daily budget 1135, monthly budget 1140 and daily frequency 1145 may be specified for target string 1120, to be associated with the campaign or sub-campaign for use in the real-time automated bidding process. As well, advertisements or creatives to be associated with the campaign or sub-campaign may be added by clicking ‘+ADD’ link 1150.

Preferably, the advertiser may review changes before they are finalized by writing changes to the account record corresponding to the advertiser in account database 16. Also, campaign manager 14 preferably maintains a list in local memory of all sub-campaigns that have been modified (i.e., added, deleted or updated) since the last operation of QA compiler 66.

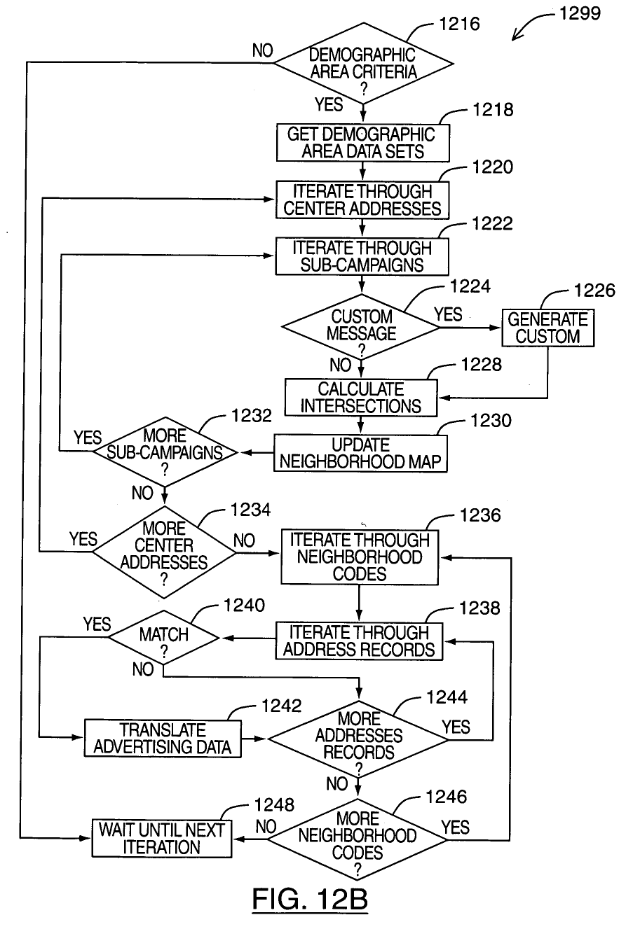

Referring now to FIGS. 12A and 12B, there is shown a flowchart diagram illustrating the operation 1299 of a query answer compiler, according to one exemplary embodiment. QA compiler 66 determines associations (‘translates’) between account database 16 data structure and address database 68 data structure. Preferably, QA compiler 66 reads data from advertising section 420 of the advertiser account records in account database 16 and translates the data to advertising information section 320 of the address data records within address database 68, as well as to data storage within rank engine 32. QA compiler preferably runs periodically as a background operation to avoid reducing performance of the real-time automated bidding process.

QA compiler 66 preferably receives anonymized sub-campaign data from campaign manager 14 in the form of a compiler list, comprising zero or more sub-campaign IDs, and creates a copy of the compiler list within its local memory.

According to a preferred embodiment, at step 1200, QA compiler 66 identifies sub-campaigns that lack custom demographic target criteria and demographic area target criteria (i.e., they are ‘non-address specific’) and send those sub-campaign IDs direcly to rank engine 32 to store those sub-campaign IDs in a global sub-campaign list. Consequently, those non-address specific sub-campaign IDs may be removed from the compiler list. In one embodiment, QA compiler 66 may also identify sub-campaigns that have custom demographic or demographic area target criteria, but the target criteria specifies that a match may also occur if other criteria are met (i.e., the target criteria equation has a logical OR operation). QA compiler 66 may send the sub-campaign IDs of such sub-campaigns with multiple match criteria to the rank engine 32, to store those sub-campaign IDs in the global sub-campaign list of the rank engine 32, but leave the sub-campaign IDs in the compiler list.

Following step 1200, the compiler list should preferably comprise only sub-campaigns that have custom demographic and/or demographic area target criteria (‘address specific’). At step 1202, QA compiler 66 determines if there are any sub-campaigns that reference custom demographic criteria. If none of the sub-campaigns remaining in the compiler list reference any custom demographic criteria, QA compiler 66 proceeds directly to step 1216. Otherwise, QA compiler 66 retrieves the custom demographic data sets referenced by the sub-campaigns in the compiler list at step 1204.

At step 1206, QA compiler 66 iterates through a list of postal addresses in each custom demographic data set. For each current postal address in a current custom demographic data QA compiler 66 determines if a corresponding address record exists in address database 68 at step 1208. If the current postal address does not have a corresponding record in the address database 68, QA compiler proceeds directly to step 1214. Otherwise, at step 1210, using the information from the address record corresponding to the current postal address (e.g. postal address 304, latitude 308, longitude 310, neighborhood code 312, city code 314, country code 316 and ISP code 318) QA compiler iterates through and evaluates sub-campaign target criteria that reference the current custom demographic data set for a match. If no match is found, QA compiler 66 proceeds to step 1214. Otherwise, at step 1212, for each match QA compiler 66 translates the data from the corresponding sub-campaign section 452 of account database 16 to the advertising section 320 of the address record that matches the current postal address in address database 68.

Once the current postal address from the current custom demographics data set has been fully evaluated, QA compiler 66 checks at step 1214 for more postal addresses in the current custom demographics data set or in the next custom demographics data set. If more postal addresses exist within the relevant demographic data sets, QA compiler 66 returns to step 1206.

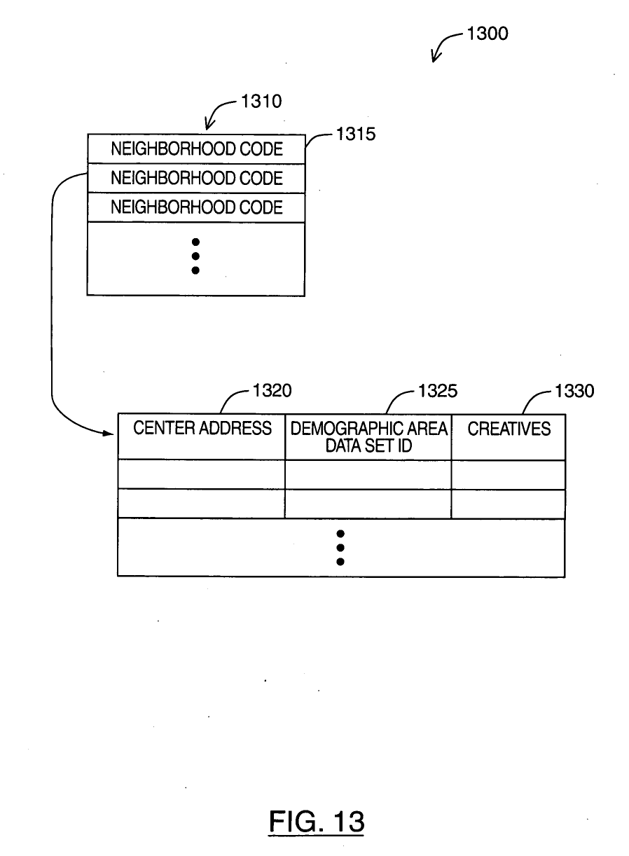

At step 1216, QA compiler 66 determines if any sub-campaigns in the compiler list reference any demographic area target criteria. If there are not any sub-campaigns that reference the demographic area target criteria, QA compiler 66 proceeds to step 1248 and waits for the next periodic iteration. Otherwise, at step 1218, QA compiler 66 preferably initializes data structure 1300 in local memory, as shown in the example of FIG. 13. Data structure 1300 preferably comprises a temporary neighborhoods map 1310, containing a list of neighborhood codes 1315, each pointing to a list of relevant center addresses 1320, demographic area data set ID 1325 and associated advertisements 1330.

At step 1218, QA compiler 66 retrieves demographic area data sets referenced by sub-campaigns in the compiler list. Next, at step 1220, QA compiler 66 iterates through each center address in each demographic area data set. For each iteration in the current demographic area data set, QA compiler 66 at step 1222 again iterates through each sub-campaign that references the current demographic area data set. At step 1224, QA compiler 66 determines if there exists a custom message 600 associated with the current center address. If yes, at step 1226, QA compiler 66 adds the custom message to each advertisement associated with the sub-campaign, assigns a unique creative ID and stores the customized advertisement in the same data storage device as the other advertisements (i.e., ad storage repository 154 in delivery system 36).

At step 1228, QA compiler 66 takes the current center address, the inner radius and the outer radius from the target criteria of the current sub-campaign to calculate which neighborhood codes are intersected by the circular band defined by the center address, the inner radius and the outer radius. In other embodiments, QA compiler 66 may calculate neighborhoods falling within an area defined by alternate geometries at step 1228. For example, rather than receiving a center address and radii, QA compiler may receive multiple addresses or coordinates defining vertices of a polygon and calculate neighborhood codes intersecting the area defined by the polygon.

At step 1230, QA compiler 66 updates the neighborhoods map 1310 with intersecting neighborhood codes and associated data. Once the current sub-campaign has been fully evaluated, the QA compiler 66 checks for more sub-campaigns that reference the current demographic area data set at step 1232, and returns to step 1222 if more sub-campaigns are found. Otherwise, at step 1234, QA compiler 66 determines if there are more center addresses in the current demographics area data set or in the next demographic area data set. If more center addresses exist in the relevant demographic area data sets, QA compiler 66 returns to step 1220.

Otherwise, at step 1236, QA compiler 66 begins iterating through each neighborhood code 1315 within the completed neighborhoods map 1310 and, at step 1238, QA compiler 66 begins iterating through each address record in address database 68 that corresponds to the current neighborhood code from within the neighborhood map 1310. At step 1240, QA compiler 66 determines if a the current address record (e.g., postal address 304, latitude 308, longitude 310, neighborhood code 312, city code 314, country code 316 and ISP code 318) matches target criteria for sub-campaigns whose demographic area data set IDs 1325 correspond to the current neighborhood code 1315 within the neighborhoods map 1310. For each sub-campaign whose target criteria matches the information in the current address record, QA compiler 66 translates data at step 1242 from the corresponding sub-campaign section 452 of the account database 16 to the advertising section 320 of the current address record in address database 68.

Once the current address record has been fully evaluated, QA compiler 66 checks for more address records that match the current neighborhood code at step 1244 and returns to step 1238 if any matches are found. Otherwise, QA compiler 66 checks for more neighborhood codes 1315 within the neighborhoods map 1310 at step 1246 and returns to step 1236 if more neighborhood codes 1315 are found. Otherwise, QA compiler 66 discontinues processing and waits for the next periodic iteration, at step 1248.

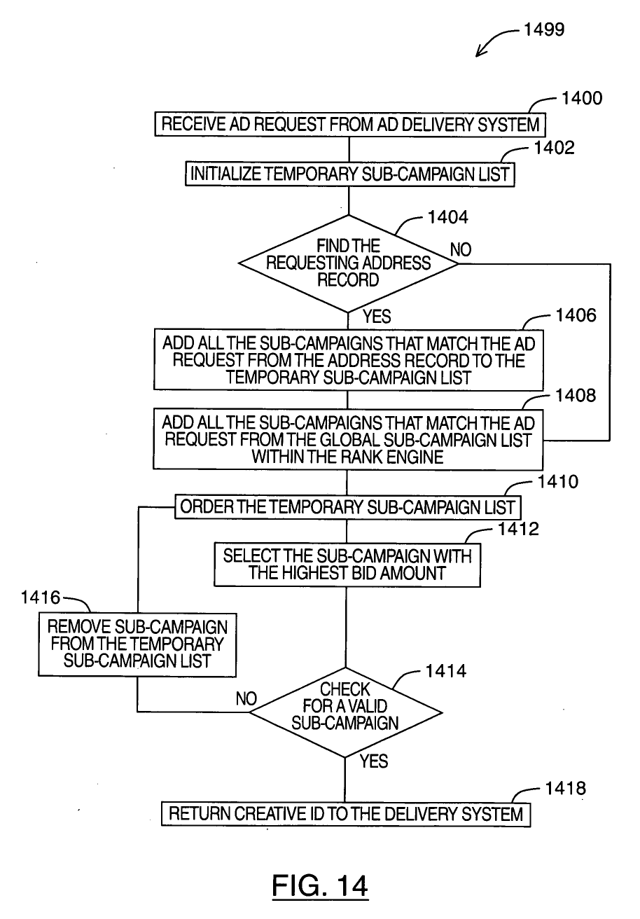

Referring now to FIG. 14, there is shown a flowchart diagram illustrating the operation 1499 of a rank engine in accordance with one exemplary embodiment. At step 1400, rank engine 32 receives data from ad request handler 150 of delivery system 36 in the form of an ad request. Preferably, the ad request is comprised of at least the IP address of a subscriber 110. The ad request may also include other information relevant to the request, such as behavioral information and website content information, as well as an ad network ID, if applicable.

At step 1402, rank engine 32 initializes a temporary sub-campaign list in local memory to contain sub-campaign IDs relevant to the ad request. At step 1404, rank engine 32 determines if the IP address associated with the ad request has an address record within address database 68. If the IP address does not have an address record in address database 68, rank engine 32 proceeds directly to step 1408. If rank engine 32 finds an address record in address database 68 for the IP address, rank engine 32 at step 1406 retrieves all the sub-campaign IDs from advertising information section 320 of the address record corresponding to the IP address associated with the ad request and adds all the sub-campaigns that match the ad request to the sub-campaign list created in step 1402.

At step 1408, rank engine 32 adds the sub-campaign IDs of all sub-campaigns relevant to the ad request found in the global sub-campaigns list. The sub-campaign list is sorted according to bid amount at step 1410 and, at step 1412, rank engine 32 selects the sub-campaign with the highest bid from the generated sub-campaign list. At step 1414, rank engine 32 validates the selected sub-campaign. For example, rank engine 32 may determine if the selected sub-campaign is within its presentation limits (e.g., the daily limit has not yet been reached). If the sub-campaign is not currently valid, rank engine 32 removes the sub-campaign from the sub-campaign list created at step 1416 and returns to step 1412. If the sub-campaign is currently valid, rank engine 32 at step 1418 returns the appropriate creative ID to ad request handler 150 within delivery system 36, whereupon delivery system 36 delivers the appropriate advertisement to subscriber 110.

It will be appreciated that various embodiments may comprise one or more special purpose or general purpose computers or servers, each of which may include, but are not limited to, one or more processors, memories, storage devices, input/output devices and network interfaces. Likewise, the terms ‘computer’ and ‘server’ may be interchangeable in accordance with the above description. Furthermore, embodiments may be implemented as computer software instructions stored on a computer readable medium and executed in memory by processors on one or more of the computers or servers contemplated above. Although embodiments have been described as separate components, it will be understood that various components could be combined into a single computer or server, or implemented across multiple computers or servers all connected via a communications medium such as the Internet.

Numerous specific details are set forth herein in order to provide a thorough understanding of the exemplary embodiments described herein. However, it will be understood by those of ordinary skill in the art that these embodiments may be practiced without these specific details. In other instances, well-known methods, procedures and components have not been described in detail so as not to obscure the description of the embodiments. Furthermore, this description is not to be considered as limiting the scope of these embodiments in any way, but rather as merely describing the implementation of these various embodiments.

1. An advertising system for determining a network location associated with a physical location comprising:
(a) an advertiser module having a first communication interface, for accepting an advertisement identifier and a targeting criterion associated with an advertisement, computing a plurality of restricted identifiers satisfying the targeting criterion, and storing the advertisement identifier, the targeting criterion and the plurality of restricted identifiers in a first computer database, wherein the advertisement identifier identifies the advertisement;
(b) an intermediate module having a second communication interface, for receiving the advertisement identifier and the plurality of restricted identifiers from the advertiser module, storing the advertisement identifier and the plurality of restricted identifiers in a second computer database, communicating the plurality of restricted identifiers to at least one service provider, receiving an indication of a plurality of non-restricted identifiers associated with the plurality of restricted identifiers, and associating the advertisement identifier with the plurality of non-restricted identifiers; and
(c) an association module operated by the at least one service provider having a third communication interface, the association module for receiving the plurality of restricted identifiers, associating the plurality of restricted identifiers with the plurality of non-restricted identifiers stored in a third computer database, and communicating the indication of the plurality of non-restricted identifiers to the intermediate module.

2. The system of claim 1, wherein the targeting criterion comprises personally identifying information about a subscriber of the at least one service provider.

3. The system of claim 1, wherein the targeting criterion is data that is correlatable with postal addresses.

4. The system of claim 1, wherein the targeting criterion is selected from the group consisting of: names, postal addresses, postal codes, e-mail addresses, network equipment identifiers, government-issued alphanumeric identification strings, privately-issued alphanumeric identification strings, behavioral profiles, website content profiles, administrative divisions, municipal districts, school districts, electoral districts, demographic market areas, neighborhood trading areas, geographic identifiers, and geographic area identifiers.

5. The system of claim 4, wherein the geographic area identifiers comprise at least one geographic center point, at least one inner radius defining an inner circular border and at least one outer radius defining an outer circular border of a geographical area that is between the inner circular border and the outer circular border when both the inner circular border and the outer circular border are centered on the at least one geographic center point.

6. The system of claim 4, wherein the geographic area identifiers define polygonal vertices of a geographical area.

7. The system of claim 1, wherein the plurality of restricted identifiers comprises postal addresses.

8. The system of claim 1, wherein the plurality of non-restricted identifiers is selected from the group consisting of: network addresses, Internet Protocol addresses, telephone numbers, and hash codes.

9. The system of claim 1, wherein the advertising module further accepts a first maximum bid amount associated with the advertisement identifier and at least one additional advertisement identifier with associated maximum bid amount and targeting criterion, and communicates the first maximum bid amount and the associated maximum bid amount to the intermediate module; and the intermediate module selects the advertisement identifier associated with the highest maximum bid amount when determining the advertisement identifier to associate with the plurality of non-restricted identifiers.

10. An advertising method for determining a network location associated with a physical location comprising:
(a) providing an advertiser module, an intermediate module and an association module, wherein each of the modules has a communication interface;
(b) receiving an advertisement campaign and a targeting criterion associated with the advertisement campaign at the advertiser module;
(c) computing an advertisement identifier and a plurality of restricted identifiers satisfying the targeting criterion, storing the advertisement identifier, the targeting criterion and the plurality of restricted identifiers in a first computer database and communicating the advertisement identifier and the plurality of restricted identifiers to the intermediate module;
(d) receiving the advertisement identifier and the plurality of restricted identifiers at the intermediate module and storing the advertisement identifier and the plurality of restricted identifiers in a second computer database;
(e) communicating the plurality of restricted identifiers to the association module;
(f) computing at the association module a plurality of non-restricted identifiers, drawn from a third computer database, associated with the plurality of restricted identifiers;
(g) communicating an indication of the plurality of non-restricted identifiers associated with the plurality of restricted identifiers to the intermediate module; and
(h) based on the indication, associating the advertisement identifier to the plurality of non-restricted identifiers.

11. The method of claim 10, wherein the targeting criterion comprises personally identifying information about a subscriber of at least one service provider.

12. The method of claim 10, wherein the targeting criterion is data that is correlatable with postal addresses.

13. The method of claim 10, wherein the targeting criterion is selected from the group consisting of: names, postal addresses, postal codes, e-mail addresses, network equipment identifiers, government-issued alphanumeric identification strings, privately-issued alphanumeric identification strings, behavioral profiles, website content profiles, administrative divisions, municipal districts, school districts, electoral districts, demographic market areas, neighborhood trading areas, geographic identifiers, and geographic area identifiers.

14. The method of claim 13, wherein the geographic area identifiers comprise at least one geographic center point, at least one inner radius defining an inner circular border and at least one outer radius defining an outer circular border of a geographical area that is between the inner circular border and the outer circular border when both the inner circular border and the outer circular border are centered on the at least one geographic center point.

15. The method of claim 13, wherein the geographic area identifiers define polygonal vertices of a geographical area.

16. The method of claim 10, wherein the plurality of restricted identifiers comprises postal addresses.

17. The method of claim 10, wherein the plurality of non-restricted identifiers is selected from the group consisting of: network addresses, Internet Protocol addresses, telephone numbers, and hash codes.

18. The method of claim 10, further comprising:
(i) receiving a maximum bid amount associated with the advertisement campaign;
(j) receiving at least one additional advertisement campaign with at least one associated maximum bid amount and at least one associated targeting criterion; and
(k) where the plurality of restricted identifiers satisfies both the targeting criterion and the at least one associated targeting criterion, associating, in step (h), the advertisement campaign associated with the highest maximum bid amount.

19. The method of claim 10, further comprising communicating a prohibited advertisement campaign from the association module to the intermediate module.

20. The method of claim 10, further comprising omitting at least one specific restricted identifier in the results of the association at step (f), based on a flag associated with the at least one specific restricted identifier.

21. The method of claim 18, wherein the steps of the method are performed in real time.

22. A physical computer-readable medium upon which a plurality of instructions are stored, the instructions for performing the steps of the method as claimed in claim 10.
